(19) United States
(12) Patent Application Publication
(10) Pub. No.: US 2002/0047885 A1
(43) Pub. Date: Apr. 25, 2002

(54) Recording apparatus

(76) Inventors: Makoto Miyawaki, Kanagawa (JP); Kenji Yoshinaga, Tokyo (JP)

Correspondence Address: FITZPATRICK CELLA HARPER & SCINTO, 30 ROCKEFELLER PLAZA, NEW YORK, NY, 10112, US

(21) Appl. No.: 09/933,177

(22) Filed: Aug. 21, 2001

(30) Foreign Application Priority Data
Aug. 23, 2000 (JP) 252161/2000
Aug. 23, 2000 (JP) 252162/2000
Jul. 31, 2001 (JP) 230955/2001

(51) Int. Cl. B41J 2/01

(52) U.S. Cl. 347/104

(57) ABSTRACT

A recording apparatus capable of securing the positional precision and flatness of a recording medium for the execution of high quality recording with the provision of the air passages which can adsorb the recording medium efficiently to the platen even if the recording medium is curled so as not to allow the adsorbing power to be reduced even when the opening of the platen is covered only partly by the recording medium.

The recording apparatus has a plurality of air passages communicating an opening portion arranged on a guiding surface of the platen and an opening portion arranged on a common negative pressure chamber, the sectional area of the former opening portion being smaller than the sectional area of the latter opening porting for each of the air passages.

### BACKGROUND OF THE INVENTION

1. Field of the Invention

The present invention relates to a recording apparatus provided with a recording medium supporting mechanism for the recording unit of a printer, a copying machine, facsimile equipment, or the like that prints images on a recording medium, such as paper sheet and plastic sheet, among some others.

2. Related Background Art

As the conventional recording apparatus, there is the ink jet recording apparatus that records images by discharging ink droplets in a designated width in the direction at right angles to the conveying direction of a recording medium per suspension of conveyance, while conveying the recording medium intermittently in the recording unit.

For the ink jet recording apparatus, the clearance between the nozzle surface of the recording head that discharges ink, and the recording medium is extremely small in the recording unit, while such clearance should be maintained in good precision. Otherwise, the image may be twisted by the defective impact of discharged ink droplets or stains may be caused by the contact between the recording head and the recording medium.

Therefore, a device is provided to enable the carriage that holds the recording head to scan in good precision by use of the guide shaft which presents excellent straightness, and also, enable the recording medium to be adsorbed to a flat platen by means of adsorption. For an adsorption type platen of the kind, it is generally practiced to arrange a structure to exert negative pressure in a closed space on the lower part of the platen by using a vacuum pump, a fan, or the like as the source of generating negative pressure, and exhaust the air to the outside from the closed space.

FIG. 11 is a perspective view which shows the conventional recording apparatus. In FIG. 11, a recording medium 201 is supplied into the apparatus in the direction indicated by an arrow K. A carrying roller 202 pinches the recording medium 201 in cooperation with pinch rollers 203, 204 and 205 to convey the recording medium 201 intermittently in good precision by use of a driving system (not shown) with which these rollers are connected to rotate.

A platen 206 is arranged so as to support the recording medium 201 with a guiding surface 206a thereof on a plane when being conveyed by the carrying roller 202. A plurality of openings 210 are provided for the guiding surface 206a, which are communicated with the inner space on the lower part of the platen 206 by way of air passage. When the inner space on the lower part of the platen 206 is negatively pressured by use of a pump or a fan, the recording medium 201 is adsorbed to the guiding surface 206a of the platen 206 by the active force of adsorption through the openings 210. In this manner, the flatness of the recording medium 201 is maintained to a certain extent.

The axial direction of the guide shaft 231 is in the direction at right angles to the conveying direction of the recording medium 201 so that the guide shaft is arranged in parallel to the guiding surface 206a of the platen 206.

A carriage 232 is fitted over a guide shaft 231, and connected with linear traveling means (not shown), thus being able to travel in the directions indicated by arrows L and L′, that is, in the main scanning directions. The carriage 232 mount an ink jet recording head therein, and enables it to travel in the main scanning directions. Here, the structure is arranged so that the ink discharge surface of the recording head faces the guiding surface 206a of the platen 206. Then, the clearance between the ink discharge surface and the recording medium 201 is maintained in good precision during the main scan of the head as far as the platen 206 can correct the posture of the recording medium 201.

Also, the carriage 232 receives electric signals for discharging ink from the controller on the main body side through cables (not shown). When the recording head receives discharging signals during the main scan, the head forms, on the recording medium 201 on the platen 206, the image in the form of strip or band which is determined by the width corresponding to the discharge nozzle array and the length of main scan of the recording head. With the repetition of the aforesaid recording in a designated number per intermittent conveyance of the carrying roller 202, images of one page portion are formed on the recording medium 201.

In FIG. 11, reference numerals 201a to 201d designate the first to fourth positions of the leading end of the recording medium 201 when an image is formed in the vicinity of the leading end of the recording medium 201. This is the method in which the binalized image data are processed through masks, and the adjacent pixel data onto the recording medium are converted into the data dispersed to the discharge nozzles within the four areas W1, W2, W3, and W4, and then, the main scan and sub-scan are repeated four times to obtain the final image. With this method, it becomes possible to equalize the image characteristics of each nozzle individually, hence reducing the image unevenness and the like.

When the first conveyance of the recording medium is completed, the leading end of the recording medium 201 is positioned at 201a in order to form the image strip equivalent to ¼ of the maximum recording width W corresponding to the discharge nozzle array of the recording head by the area W1 of the nozzle array thereof.

When the second conveyance of the recording medium is completed, the leading end of the recording medium 201 is positioned at 201b in order to form the image strip equivalent to 2/4 of the maximum recording width W corresponding to the discharge nozzle array of the recording head by the areas W1 and W2 of the nozzle array thereof.

When the third conveyance of the recording medium is completed, the leading end of the recording medium 201 is positioned at 201c in order to form the image strip equivalent to ¾ of the maximum recording width W corresponding to the discharge nozzle array of the recording head by the areas W1, W2, and W3 of the nozzle array thereof.

When the fourth conveyance of the recording medium is completed, the leading end of the recording medium 201 is positioned at 201d in order to form by the areas W1, W2, W3, and W4 of the nozzle array thereof the image strip equivalent to the maximum recording width W which is the length of the discharge nozzle array of the recording head.

However, the conventional recording apparatus has the problems given below.

In other words, the configuration of air passage which is communicated with the opening portions 210 provided for the guiding surface 206a of the platen 206, particularly that of the vertical section, has not been given sufficient consideration. When recording is made on the leading end of the recording medium 201, only a part of plural openings 210 is covered by the recording medium 201, and if there is any opening 210 which is not covered by the recording medium 201, the air outside is sucked through such opening 210 to increase loss in the negative pressure source, hence reducing the negative pressure itself in the air passage eventually. The adsorbing power given to the recording medium 201 is lowered accordingly. As a result, it becomes easier for the edge portion of the recording medium 201 to float up from the platen 206. There is also a fear that the problem of the kind is encountered in the widthwise direction of the recording medium, that is, on the edge portion of the recording medium in the main scanning directions.

Also, for the conventional recording apparatus, consideration has not been given sufficiently with respect to the distribution arrangement of openings 210 provided for the guiding surface 206a of the platen 206.

In other words, when recording is made on the leading end of the recording medium 201, the leading edge 201a of the recording medium 201 is in the positional relations to cover a part of an opening 210a or a right edge 201r of the recording medium 201 partly covers an opening 210b in some cases.

If the edge portion of a recording medium is in the positional relation that it covers the opening partly, the disturbance of air flow occurs in the vicinity of the edge portion of the recording medium, thus affecting the discharging direction when ink is discharged onto near the edge portion. As a result, it becomes easier to invite the degradation of image quality. Also, there is a fear that ink tends to spread to the edge marginal portion and cause it to be stained or cause ink to adhere to the reverse side of the recording medium which overhangs above the openings and stain that side of the recording medium in some cases.

Also, when the recording medium 201 is affected by the environmental changes accompanied by the changes of humidity, the recording medium is caused to curled up in the vicinity of the front, rear, left and right edges thereof in the direction away from the platen 206. When the edge portions of the recording medium 201 are curled up, there is a fear that the recording medium 201 is caused to part from the guiding surface 206a of platen 206 and the adsorption power is reduced inevitably.

Further, if the recording medium 201 is in the positional relations that the edge portions thereof partly covers the openings, it becomes impossible to generate the adsorption power good enough to correct the curls of the recording medium.

Also, if the recording medium should part from the platen due to curling to increase the amount of the air outside to be sucked into the openings, the air flow on the upper part of the platen is disturbed to affect the direction in which ink droplets are discharged from the recording head. Thus, there is a fear that the defective impact of ink droplets is invited to produce adverse effect on the preciseness thereof or ink is caused to spread and stain the surrounding portion unexpectedly.

### SUMMARY OF THE INVENTION

The present invention is designed in consideration of the problems discussed above. It is an object of the invention to provide a recording apparatus capable of securing the positional precision and flatness of a recording medium for the execution of high quality recording with the provision of the air passages which can adsorb the recording medium efficiently to the platen even if the recording medium is curled so as not to allow the adsorbing power to be reduced even when the opening of the platen is covered only partly by the recording medium.

It is another object of the invention to provide a recording apparatus capable of securing the positional precision and flatness of a recording medium by adsorbing further the recording medium efficiently to the platen even if the recording medium is curled.

Also, it is still another object of the invention to provide a recording apparatus for recording images on a recording medium by use of recording means which comprises a platen having a guiding surface for supporting the recording medium in a position facing recording means, negative pressure generating means for generating negative pressure to adsorb the recording medium to the guiding surface, and a plurality of air passages communicating a first opening portion arranged on the guiding surface and a second opening portion arranged on the negative pressure generating means side. For this recording apparatus, the sectional area of the first opening portion is smaller than the sectional area of the second opening porting for each of the air passages.

It is a further object of the invention to provide a recording apparatus for recording images on a recording medium by use of recording means which comprises a platen having the guiding surface in a position facing recording means to support the recording medium, negative pressure generating means for generating negative pressure to adsorb the recording medium to the guiding surface, and a plurality of air passages communicating a first opening portion arranged on the guiding surface and a second opening portion arranged on the negative pressure generating means side. For this recording apparatus, when the recording medium is intermittently conveyed on the guiding surface, the relative positional relations between the edge portion of the recording medium at rest and the first opening portion near the edge portion is substantially the same per intermittent conveyance.

It is still a further object of the invention to provide a recording apparatus for recording images on a recording medium by use of recording means which comprises a platen having the guiding surface in a position facing recording means to support the recording medium, negative pressure generating means for generating negative pressure to adsorb the recording medium to the guiding surface, and a plurality of air passages communicating a first opening portion arranged on the guiding surface and a second opening portion arranged on the negative pressure generating means side. For this recording apparatus, when the recording medium is intermittently conveyed on the guiding surface, the edge portion of the recording medium at rest is not in a position to cover the first opening portion partly.

Also, it is still a further object of the invention to provide a recording apparatus capable of performing high quality recording with the provision of air passages which can adsorb even curled recording medium to a platen efficiently so as not to allow the adsorbing power to be educed even when the recording medium covers only a part of the opening portion of the platen.

### BRIEF DESCRIPTION OF THE DRAWINGS

FIG. 1 is a perspective view which shows a recording apparatus in accordance with a first embodiment of the present invention.

FIG. 2 is a perspective view which shows a platen of the recording apparatus in accordance with the first embodiment of the present invention.

FIG. 3 is a cross-sectional view which shows the platen of the recording apparatus in accordance with the first embodiment of the present invention.

FIG. 4 is a cross-sectional view which shows the platen of the recording apparatus in accordance with the first embodiment of the present invention.

FIG. 5 is a cross-sectional view which shows a platen in the conveying direction of a recording medium in accordance with a second embodiment of the present invention.

FIG. 6 is a cross-sectional view which shows a platen in the widthwise direction of a recording medium in accordance with a third embodiment of the present invention.

FIG. 7 is a perspective view which shows a recording apparatus in accordance with a fourth embodiment of the present invention.

FIG. 8 is a view which shows the positional relations between a leading end of a recording medium and the opening portion on a guiding surface side of the recording apparatus in accordance with the fourth embodiment of the present invention.

FIG. 9 is a cross-sectional view which shows a platen in the conveying direction of a recording medium in accordance with a fifth embodiment of the present invention.

FIG. 10 is a cross-sectional view which shows a platen in the widthwise direction of a recording medium in accordance with a sixth embodiment of the present invention.

FIG. 11 is a perspective view which shows the conventional recording apparatus.

### DETAILED DESCRIPTION OF THE PREFERRED EMBODIMENTS

Hereinafter, in conjunction with the accompanying drawings, the description will be made of the embodiments in accordance with the present invention.

### First Embodiment

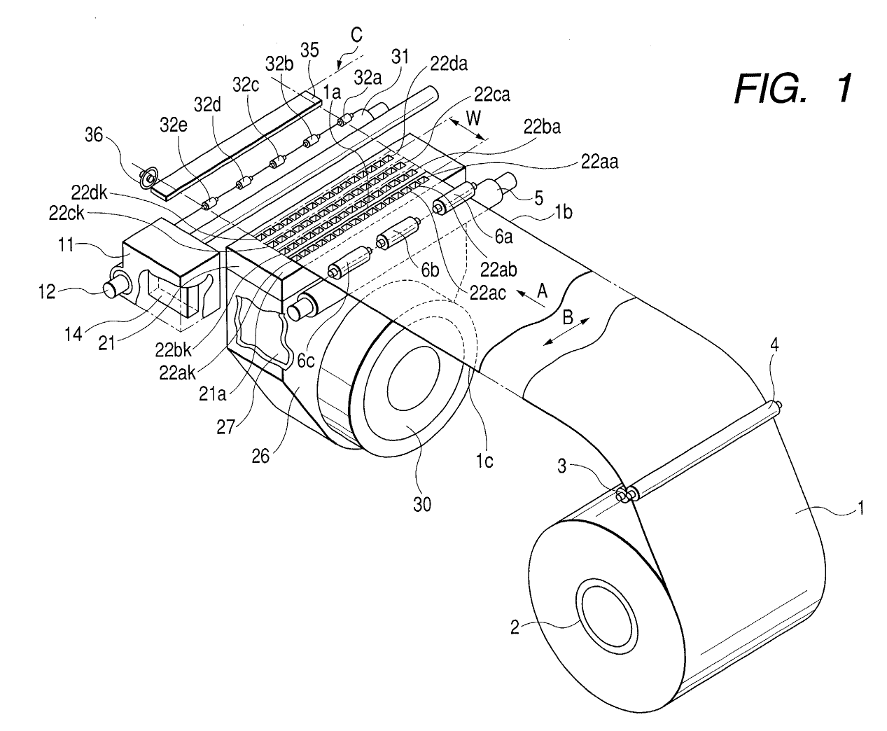

In conjunction with FIG. 1 to FIG. 4, a first embodiment of the present invention will be described. FIG. 1 is a perspective view which shows a recording apparatus in accordance with the first embodiment.

A recording medium 1 is wound around a paper tube 2 to be formed in a roll, and held rotatively centering on the paper tube 2. Drawing rollers 3 and 4 pinch the recording medium 1 and rotate in the direction indicated by an arrow A to supply the recording medium 1 in the roll to the recording unit. A carrying roller 5 and pinch rollers 6a, 6b, and 6c hold the recording medium 1 which has been supplied in the direction indicated by the arrow A to convey the recording medium 1 intermittently in good precision at pitches of a designated amount of conveyance.

A platen 21 is provided with the guiding surface 21a having almost the same height as that of the nipping portion of the carrying roller 5 and the pinch rollers 6a, 6b, and 6c. Then, in order to maintain the clearance between the nozzle surface of an ink jet recording head 14 to be described later, and the recording medium 1, the platen supports the recording medium 1 flatly in good precision. For a guiding surface 21a of the platen 21 with which the recording medium 1 is in contact, a plurality of openings 22 on the guiding surface side are arranged to serve as a first opening portion. This opening portion is a rectangular opening of 240 mm×46 mm in size, and at least, on the area where the recording medium 1 should be supported, this opening portion is arranged at pitches of 3.5 mm in the conveying direction of the recording medium, and at pitches of 12 mm in the widthwise direction of the recording medium (that is, the main scanning direction of the recording head). Then, the first opening portion is arranged so that one side of the rectangle is located along the straight edge of the leading end of the recording medium 1. In this manner, as compared with the case where the opening is configured to be circular, the fluctuation of adsorbing power can be made small until the leading end of the recording medium 1 covers the opening portion completely.

In this respect, when the leading end of the recording medium 1 is conveyed intermittently on the guiding surface 21a of the platen 21, there exists on the downstream side of the conveying direction, the opening portion 22 which is not covered by the recording medium 1 on the guiding surface 21a of the platen 21.

The circumference of the platen 21 is provided with the wall faces protruding downward, and the space surrounded by the wall faces is sealingly coupled with a fan case 26 that forms the outer walls of a common negative pressure chamber 27 serving as negative pressure generating means. A fan 30 is coupled with the lower part of the fan case 26 to exhaust the air in the common negative pressure chamber 27 to the outside with the rotation of the fan 30. In this way, the common negative pressure chamber 27 can provide negative pressure.

For the common negative pressure chamber 27, an opening portion 24 on the negative pressure chamber side serving as a second opening, and the opening portion 22 on the guiding surface side and the opening portion 24 on the negative chamber side are communicated by use of a plurality of air passages 23. The opening portion 24 on the negative pressure chamber side is an opening of 2 mm×2 mm in size. Then, when negative pressure is exerted in the common negative pressure chamber 27, an air passage 23 and the opening portion 22 on the guiding surface side can be negatively pressurized.

The carriage 11 is slidably supported by a guide shaft 12 which extends in the widthwise direction of the recording medium 1. A carriage 11 is connected with linear traveling means (not shown) to be made movable in the axial direction of the guide shaft 12 by means of instructions from controlling means.

The ink jet recording head 14 is held in the carriage 11, and connected with the controlling unit electrically by use of a connecting cable (not shown), thus controlling the ink discharges. On the lower face of the ink jet recording head 14 that faces the platen 21, the nozzle array is arranged with a width W in the direction orthogonal to the main scanning direction to make the discharge of ink droplets possible downward in FIG. 1. Then, the image of the largest width W can be recorded on the recording medium 1 by one main scanning.

An ink cartridge (not shown) which contains ink is held by the carriage 11 and made movable together with the carriage 11. Then, being coupled with the ink jet recording head 14, ink supply becomes available.

During the recording operation, the recording medium 1 is conveyed intermittently by use of the carrying roller 5, and the position of the leading end thereof shifts at the designated pitches. Then, per the completion of intermittent conveyance, the ink Jet recording head 14 travels together with the carriage 11 in the main scanning directions, thus forming the image strip in a designated with on the recording medium 1.

An expelling roller 31 and auxiliary rollers 32a to 32e rotate in synchronism with driving the carrying roller 5 for the intermittent conveyance to convey the recording medium 1 so as not to allow the recording medium 1 to float from the platen 21 or to be conveyed diagonally. The holding power (or force) of the expelling roller 31 and the auxiliary rollers 32a to 32e is set so that it is weaker than that of the carrying roller 5 and the pinch rollers 6a, 6b, and 6c. In this manner, the precision of intermittent conveyance in the recording unit is set so that it is prevailingly governed by the function of conveyance performed by the carrying roller 5 and the pinch rollers 6a, 6b, and 6c.

A lower edge 35 of the cutter is configured to extend in the widthwise direction of the recording medium 1, and is positioned almost at the same height as that of the nipping made by the expelling roller 31 and the auxiliary rollers 32a to 32e for the arrangement on the downstream side in the conveying direction of the aforesaid rollers. An edge 36 of the roller cutter is connected with the linear driving mechanism (not shown) and made movable in the widthwise direction of the recording medium 1, while being in contact with the lower edge 35 of the cutter.

After the completion of recording, the expected cutting position of the recording medium 1 is conveyed to a cutting position C in FIG. 1 by use of the carrying roller 5 and the pinch rollers 6a, 6b, and 6c, and then, cut by the movement of the edge 36 of the roller cutter. After that, the recording medium is further conveyed and expelled outside the apparatus by means of rollers and the like (not shown) arranged on the downstream in the conveying direction.

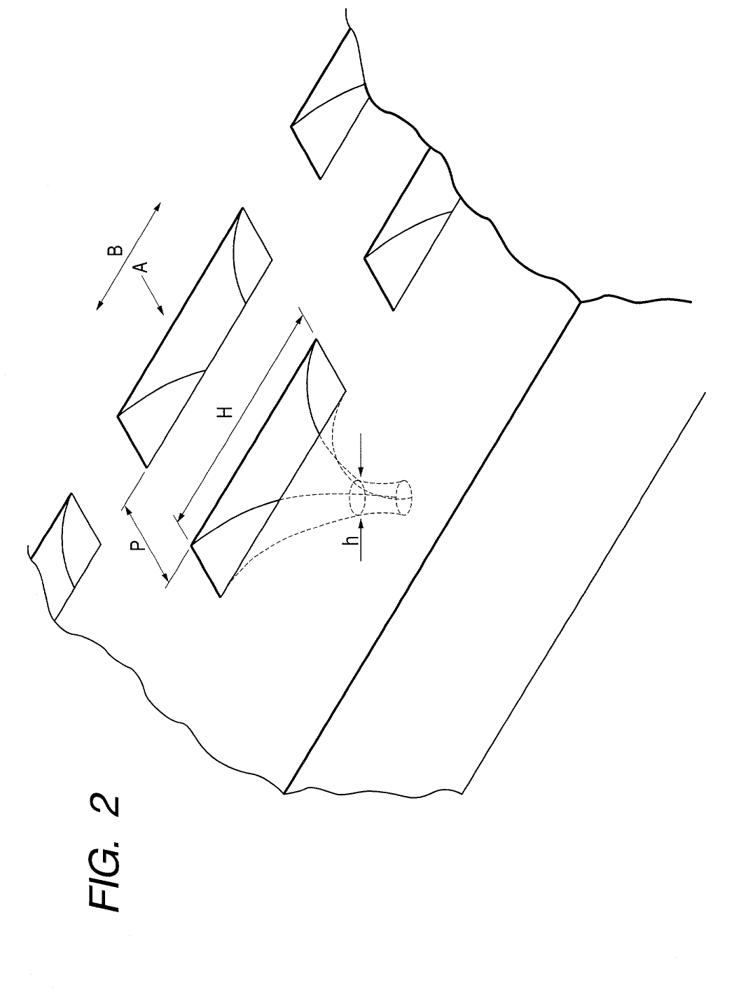

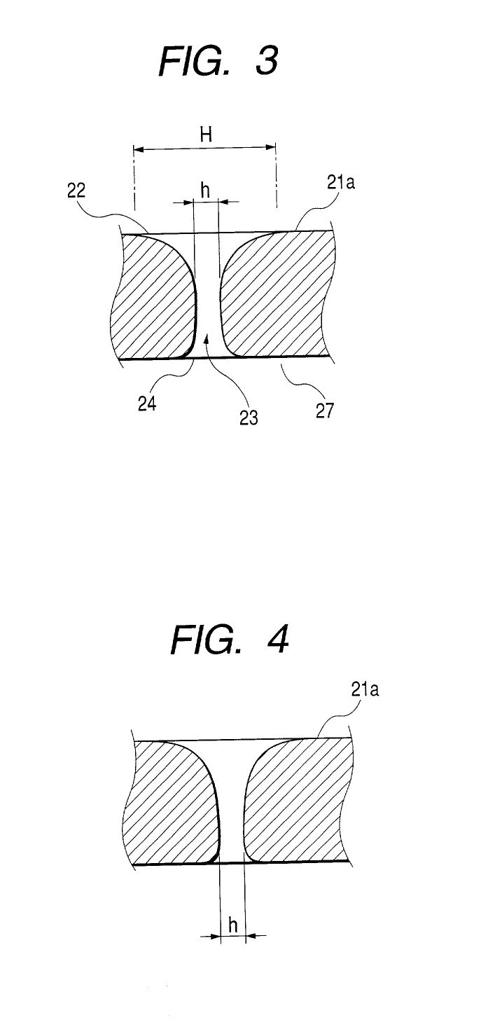

FIG. 2 is a perspective view which shows the platen of the recording apparatus in accordance with the first embodiment of the present invention. FIG. 3 is a cross-sectional view thereof.

The air passage 23 is provided with the opening 24 on the negative pressure chamber side, which has a relatively small area on the portion that face the common negative pressure chamber 27. The sectional configuration thereof is made slightly narrower so as to present a smallest sectional area h on the way, but from there toward the guiding surface 21a of the platen 21, the moderately curved wall faces are formed to gradually approach the faces parallel to the guiding surface 21a. In this way, the opening area is increased so that a largest sectional area H is provided in the vicinity of the portion which is essentially regarded as the opening portion 22 within a range where the effect of the present invention is demonstrated in terms of the suction power that sucks the opening portion 22 on the guiding surface side of the guiding surface 21a or the recording medium 1.

Conventionally, when the capacity of the common negative pressure chamber is small as the negative pressure source or the sectional configuration or the sectional shape or area of the air passage is almost constant so as to present relations that changes of pressure in the common negative pressure chamber appear directly as the equivalent changes of pressure in the opening portion on the guiding surface side, the air outside flows into the common negative pressure chamber all at once through an opening portion if there is any opening portion which is not covered by the recording medium on the guiding surface side. Then, the negative pressure is reduced (almost to the normal pressure) eventually. As a result, adsorption cannot be given efficiently. Also, simultaneously, the air flow on the upper face of the platen is disturbed to cause ink spreading in some cases.

In accordance with the air passage of the present embodiment, it becomes possible to block any extreme flow-in of the air outside by the flow-in loss resistance at the smallest sectional area h even for the opening portion 22 on the guiding surface side which is not covered by the recording medium 1. Thus, essentially, the negative pressure in the common negative pressure chamber 27 is not lowered.

Also, the configuration is arranged so that the sectional area of the air passage becomes slightly narrower on the way from the common negative pressure chamber 27 side, and the moderately curved wall faces are formed from there toward the guiding surface 21a of the platen 21 to be in contact with the recording medium 1 in order to gradually approach the face which is in parallel to the guiding surface 21a of the platen 21 for increasing the opening area, and that the largest area portion H is provided for the opening portion 22 on the guiding surface side of the guiding surface 21a or in the portion immediately before that. Therefore, when the recording medium 1 is caused to float and part from the guiding surface 21a of the platen 21, the flow rate becomes rapid in the clearance between them, and the external force is exerted from above the recording medium against any further floating thereof. As a result, the degree of reduction of adsorbing power becomes smaller against the amount of floating. Also, the disturbance of air flow above the platen 21 can be minimized to reduce ink spreading.

Also, when the opening portion 22 on the guiding surface side is covered by the recording medium 1, there occurs in the opening portion 22 on the guiding surface side though the smallest sectional area portion h, the negative pressure which is almost equal to the negative pressure in the common negative pressure chamber 27. Then, the adsorption power of a value obtainable by multiplying such negative pressure by the area of the largest sectional area portion H is exerted with respect to the recording medium 1. In this manner, an extremely efficient adsorbing action can be implemented.

FIG. 4 is a cross-sectional view which shows the air passage when the opening portion 24 on the negative pressure chamber side is made to be the smallest sectional area portion h. This is simply configured priorly in consideration of the capability to form it with resin by use of molding die. However, as a result of verification, there is no essential difference from the one configured as shown in FIG. 3 in the adsorption efficiency and the like.

When the recording medium 1 is curled upward, it is possible to suppress the recording medium 1 not to part from the platen 21 to a certain extent by the holding function of the carrying roller 5 and the pinch rollers 6a, 6b, and 6c in the first main scan on the leading end portion of the recording medium 1, and then, adsorb it by the opening portion on the guiding surface side which is arranged almost in one line with the adsorption given by openings 22aa to 22ak on the guiding surface side.

Also, as shown in FIG. 1, the right edge portion 1b of the recording medium 1 is positioned outside the line of openings 22aa, 22ba, 22ca, and 22da on the guiding surface 21a. This portion is not in the positional relations to cover a part of each opening on the guiding surface side. Likewise, the left edge portion 1c of the recording medium is positioned outside the line of openings 22ak, 22bk, 22ck, and 22dk on the guiding surface side on the guiding surface 21a. This portion is not in the positional relations to cover a part of each openings on the guiding surface side.

As recording advances, a leading end 1a of the recording medium 1 is held by the expelling roller 31 and the auxiliary rollers 32a to 32e. After that, curling of the recording medium 1 is mostly corrected by this holding function of the expelling roller 31 and the auxiliary rollers 32a to 32e. Therefore, the adsorbing power may be lowered by controlling the fan 30 or the adsorbing operation may be suspended then.

### Second Embodiment

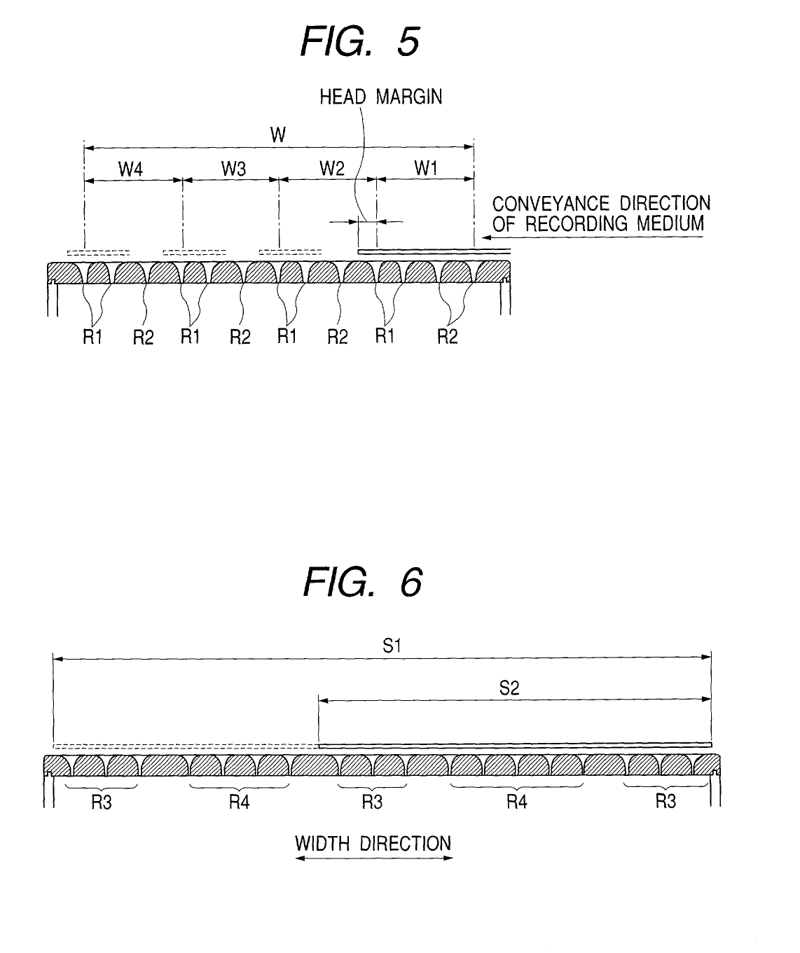

In conjunction with FIG. 5, the description will be made of a second embodiment in accordance with the present invention. The second embodiment of the invention relates to the configuration of the air passage in the conveying direction of a recording medium. FIG. 5 is a cross-sectional view which shows the platen with respect to the conveying direction of a recording medium in accordance with the second embodiment of the present invention.

In FIG. 5, a first air passage R1 and a second air passage R2 are the same in the sectional area of the opening portion on the guiding surface side, but are different in the sectional area of the opening portion on the negative pressure chamber side. The first air passage R1 is structured larger than the second air passage R2. Here, the quotient obtainable by dividing the sectional area of the opening portion on the negative pressure chamber side by the sectional area of the opening portion on the guiding surface side is defined as an opening rate. The opening rate of the first air passage R1 is larger than the opening rate of the second air passage R2. As described earlier, a reference mark W designates the largest recording width, and each of areas W1, W2, W3, and W4 is the area of the nozzle array where recording is made per main scan and intermittent conveyance. Broken lines indicate the leading end of the recording medium at each position where it comes to a stop once per intermittent conveyance.

The force that causes the recording medium to part from the platen is not constant due to curling at the leading portion and in the central portion in the conveying direction thereof. Such force is greater at the leading end portion in general. Consequently, if all the air passages should be arranged in the same configuration so as to set a constant force of adsorption, the adsorption efficiency is lowered relatively on the leading end portion due to the correction of curling.

Now, therefore, the air passage R1 having a larger opening rate is arranged on the guiding surface 21a of the platen 21 that corresponds to the leading end portion of a recording medium, and the air passage R2 having a smaller opening rate is arranged on the portion other than that. In this way, it becomes possible to adsorb the leading end portion of the recording medium intensively without fail at any timing of the intermittent conveyance.

### Third Embodiment

In conjunction with FIG. 6, the description will be made of a third embodiment in accordance with the present invention. The third embodiment relates to the configuration of the air passage with respect to the widthwise direction of a recording medium for a recording apparatus that can use recording mediums each in different size. FIG. 6 is a cross-sectional view which shows the plate with respect to the widthwise direction of a recording medium in accordance with the third embodiment of the present invention.

In FIG. 6, a third air passage R3 and a fourth air passage R4 are the same in the sectional area of the opening portion on the guiding surface side, but are different in the sectional area of the opening portion on the negative pressure chamber side. The third air passage R3 is structured to be larger than the fourth air passage R4. In other words, the opening rate of the third air passage R3 is larger than the opening rate of the fourth air passage R4.

The force that causes the recording medium to part from the platen is not constant due to curling at the leading portion and in the central portion in the widthwise direction thereof. Such force is greater at the edge portion in general. Consequently, if all the air passages should be arranged in the same configuration so as to provide the adsorption power constantly, the adsorption efficiency is lowered relatively on the edge portion due to the correction of curling.

Now, therefore, although the arrangement pitches of the air passages are constant, the air passage R3 having a larger opening rate is arranged on the guiding surface 21a of the platen 21 which corresponds to the edge portion of a recording medium, and the air passage R4 having a smaller opening rate is arranged for the part other than that. Also, the number of air passages having a larger opening rate, which should be located on the left and right edges of the recording medium, and in the vicinity thereof as well, is arranged to keep symmetry substantially on the left and right sides per different size of width. In this manner, adsorption begins gradually with the central portion of the recording medium 1 where the clearance is smaller from the platen 21, and along with this, the clearance on the edge portions are reduced accordingly. As a result, the clearance in which adsorption is exercised becomes smaller on the edge portions where the adsorption efficiency should be increased. In other words, it becomes possible to maintain the adsorption efficiency for correcting the curled edges without any particular measures taken to increase the capacity of the negative pressure source extremely to serve the purpose.

### Fourth Embodiment

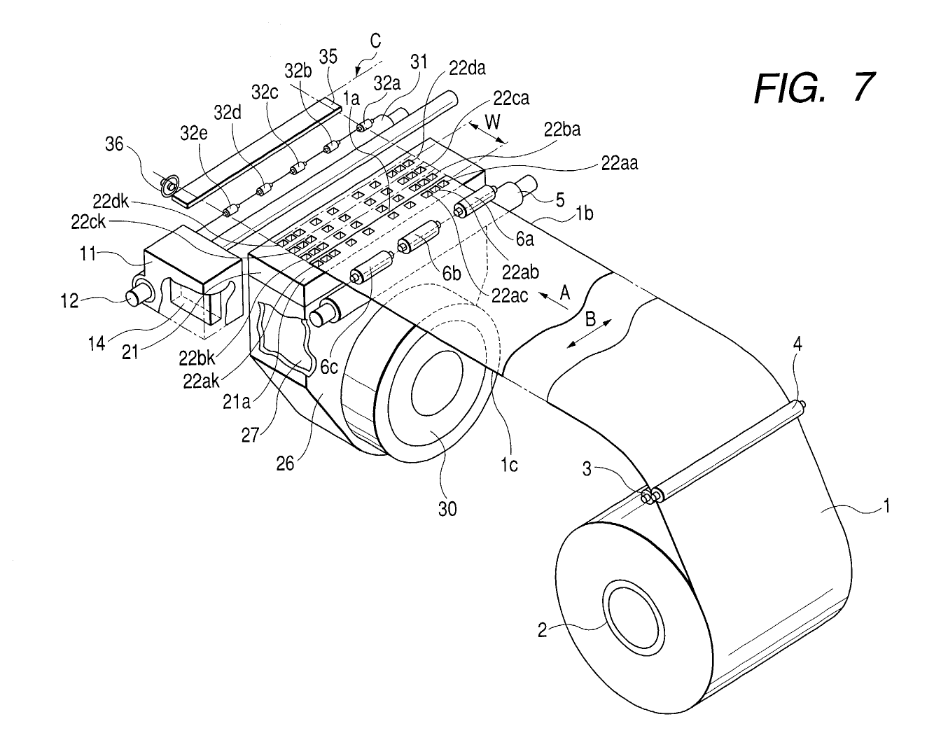

FIG. 7 is a perspective view which shows a recording apparatus in accordance with a fourth embodiment. FIG. 7 represents the modified arrangement of the opening portion 22 on the guiding surface side arranged for the guiding surface 21a of the platen 21 shown in FIG. 1 which is the perspective view of the recording apparatus of the first embodiment in accordance with the present invention. In this respect, FIG. 7 also serves as a perspective view of a recording apparatus in accordance with the fifth and sixth embodiments which will be described later.

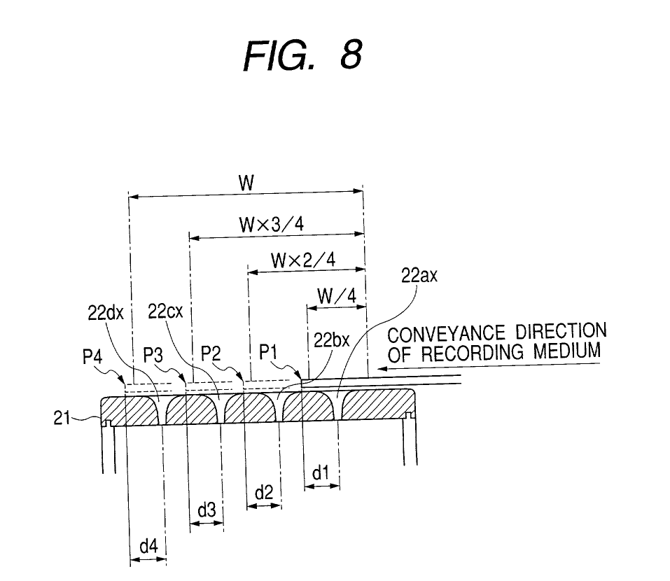

FIG. 8 is a cross-sectional view which shows the positional relations between the leading end 1a of a recording medium 1 and the opening portion 22 on the guiding surface side when a recording operation is executed. The arrangement pitches of the opening portion 22 on the guiding surface side in the conveying direction of a recording medium 1 is set at the same amount as that of intermittent conveyance of the recording medium 1.

For the present embodiment, the leading end 1a of the recording medium 1 is conveyed to an interval P1 between the first line of the openings 22aa to 22ak on the guiding surface side and the second line of the openings 22ba to 22bk on the guiding surface side before the first recording scan. After that, an image is recording in a width of W/4. Then, after the leading end 1a of the recording medium 1 is conveyed to the interval P2 between the second line of the openings 22ba to 22bk on the guiding surface side and the third line of the openings 22ca to 22ck on the guiding surface side before the second recording scan, the image is recording in a width of W/4. Then, the third and fourth recording are executed likewise. Here, the leading end 1a of the recording medium 1 is not in the positional relations at all to cover only a part of each opening portion 22 on the guiding surface side when any one of the recording scans is executed.

The clearances each at d1, d2, d3, and d4 between the leading end 1a of the recording medium 1 and the opening portion 22 on the guiding surface side near thereto per recording scan is the same at an optimal value for the execution of recording. The relative positional relations between the leading end 1a of the recording medium 1 and the opening portion 22 on the guiding surface side near thereto is made substantially the same per recording scan. Therefore, the adsorbing condition is constant at the leading end 1a of the recording medium 1, and unlike the conventional example, the adsorption for the recording medium 1 does not becomes weaker at any specific recording scan or the air flow above the recording medium 1 is not disturbed. Also, if the amount of intermittent conveyance of the recording medium 1 is set at a value integral times the arrangement pitches of the opening portion 22 on the guiding surface side in the conveying direction of the recording medium 1, the positional relations between the leading end 1a of the recording medium 1 and the opening portion 22 on the guiding surface side 22 near thereto can be maintained per intermittent conveyance to stabilize the adsorbing condition.

When the edge portions of a recording medium 1 present curling upward, it is possible to suppress the clearance between the recording medium 1 and the guiding surface 21a of the platen 2 to a certain extent by the holding function of the carrying roller 5 and the pinch rollers 6a, 6b, and 6c at the position P1 for the first recording scan at the leading end region of the recording medium 1, and with the adsorption of the openings 22aa to 22ak on the guiding surface side, the recording medium is adsorbed substantially by one line of the opening portions on the guiding surface side.

At the time of first recording scan, the recording medium 1 is adsorbed efficiently by the first line of the openings 22aa to 22ak on the guiding surface side, and the leading end 1a of the recording medium 1 is substantially in close contact with the guiding surface 21a of the platen 21. Therefore, the adsorbing power acts efficiently upon the recording medium which is further conveyed to the position for the second scan.

When the curled leading end 1a of a recording medium 1 is positioned at P2 or P4 for the second recording scan and on, the leading end 1a is far away form the nipping position of the carrying roller 5 and the pinch rollers 6a, 6b, and 6c, thus reducing the holding effect thereof. As a result, the recording medium 1 tends to be restored to the curled condition at the outset. Now, if the adsorption loss should be great as in the case of the conventional example in such a condition as this, the clearance between the guiding surface 21a of the platen 21 and the leading end 1a of the recording medium 1 is increased. However, in accordance with the present embodiment, it is arranged to provide the opening portion 22 on the guiding surface side capable of adsorbing the portion near the leading end 1a of the recording medium 1 per intermittent conveyance, hence making it possible to keep the leading end 1a of the recording medium 1 and the guiding surface 21a of the platen 21 in close contact even at the position for the second recording scan and on.

Also, as shown in FIG. 7, the right edge portion 1b of the recording medium 1 is positioned outside the line of the openings 22aa, 22ba, 22ca, and 22da on the guiding surface side on the guiding surface 21a, and is not in the positional relations to cover a part of each of the openings on the guiding surface side. Likewise, the left edge portion 1c is positioned outside the line of the openings 22ak, 22bk, 22ck, and 22dk on the guiding surface side on the guiding surface 21a, and is not in the positional relations to cover a part of each of the openings on the guiding surface side.

The recording operation advances, and after the leading end 1a of the recording medium 1 is held by the expelling roller 31 and the auxiliary rollers 32a to 32e, the curling of the recording medium 1 is substantially corrected by the holding function of the expelling roller 31 and the auxiliary rollers 32a to 32e. Thus, it may be possible to control the fan 30 in order to lower the adsorbing power or suspend the operation of adsorption.

Also, as shown in FIG. 7, the arrangement pitches of opening portion 22 on the guiding surface side in the vicinity of edge portions 1b and 1c in the widthwise direction of the recording medium 1 are made smaller than the arrangement pitches of the opening portion 22 on the guiding surface side other than the edge portions of the recording medium 1 in order to deal with a recording medium having the property which makes the left and right edges thereof easier to be curled upward. Here, if the opening portion 22 on the guiding surface side is arranged closely as a whole, it results in the increased numbers of openings 22 on the guiding surface side that does not cover the recording medium 1 when recording is made on the leading end portion of the recording medium 1. Then, the loss in the negative pressure sources is increased to lower the absorption efficiency for correcting the curled edge portions of the recording medium 1. For the present embodiment, therefore, it is arranged to begin adsorption gradually from the central portion of the recording medium 1 where the clearance with the platen 21 is smaller. Then, along with this, the edge portions reduce the clearance to enhance the adsorption efficiency of the opening portion 22 on the guiding surface side.

### Fifth Embodiment

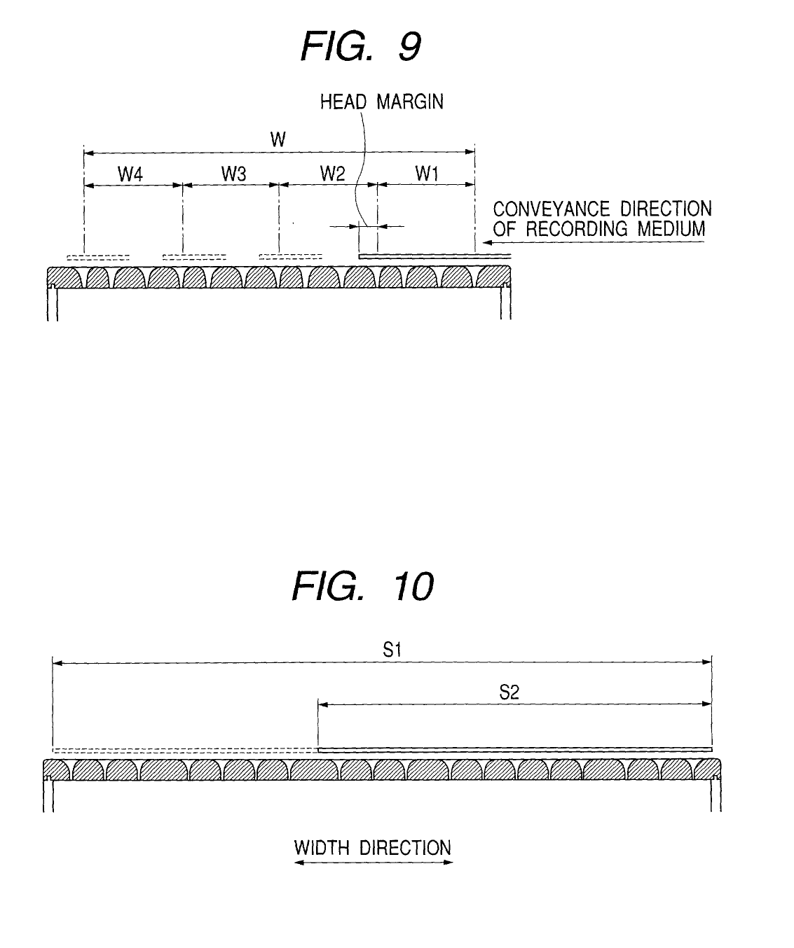

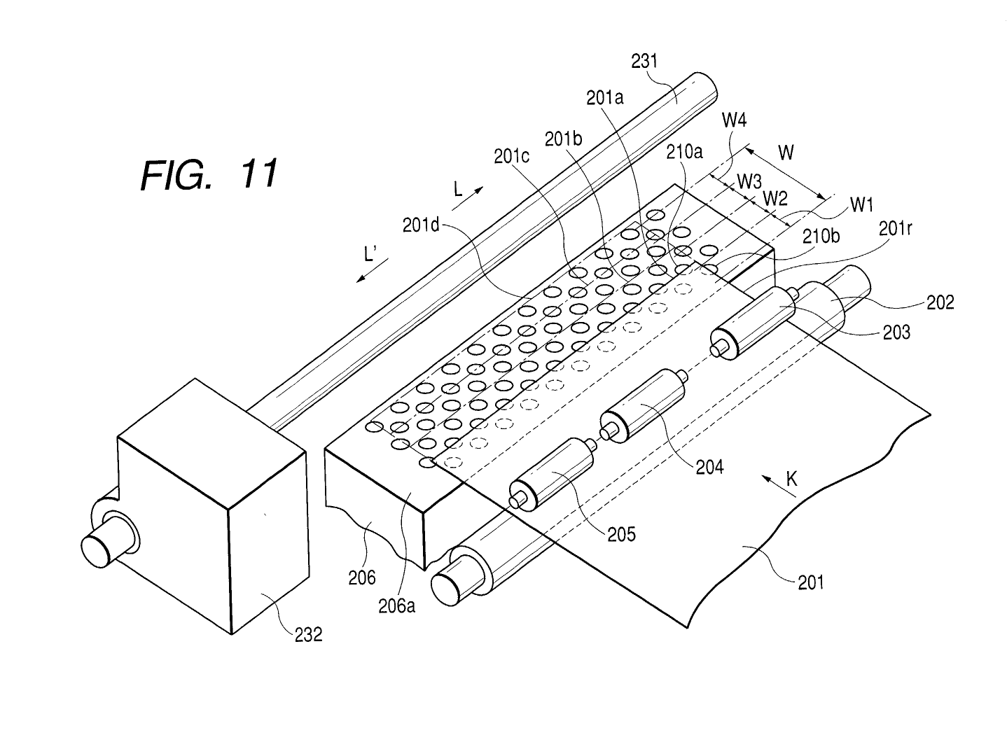

In conjunction with FIG. 9, the description will be made of a fifth embodiment in accordance with the present invention. The fifth embodiment relates to the configuration of the air passage in the conveying direction of a recording medium. FIG. 9 is a cross-sectional view which shows the platen in the conveying direction of the recording medium in accordance with the fifth embodiment of the present invention.

In FIG. 9, plural lines of air passages are arranged for each of the intermittent conveyance pitches to form a structure capable of dealing with a recording medium having the tendency to present upward curling more intensively. At each scanning position, the arrangement pitches of air passages to deal with the leading portion of a recording medium are made smaller to increase the adsorption activating power per unit area, hence making it possible to enhance the adsorption activating force at the leading end portion of the recording medium which is liable to be influenced by curling.

### Sixth Embodiment

In conjunction with FIG. 10, the description will be made of a sixth embodiment in accordance with the present invention. The sixth embodiment relates to the configuration of the air passage in the widthwise direction of a recording medium for a recording apparatus that deals with plural mediums of different sizes. FIG. 10 is a cross-sectional view which shows the platen in the widthwise direction a recording medium in accordance with the sixth embodiment of the present invention.

In FIG. 10, the arrangement is made so as not to allow the edge portions of the recording medium to cover a part of any one of the openings 22 on the guiding surface in the widthwise direction of the recording medium irrespective of each of the sizes S1 and S2. The arrangement pitches of the air passages on the edge portions of each recording medium in the widthwise direction are made smaller than that of the central portion of the recording medium. Also, the relative positional relations between the left and right edges of the recording medium and the openings on the guiding surface side in the vicinity thereof are kept substantially the same for each size. Further, the arrangement is made so that in the position of recording scan after each of the intermittent, the relative positional relations between the left and right edges of the recording medium and the openings on the guiding surface side in the vicinity thereof are kept substantially the same. For the left and right edge portions of any recording medium having different size in width, the left and right edge of the recording medium is sucked substantially on the same condition at each position of intermittent scans, making it possible to record images in high quality in the vicinity of left and right edge portions of each size.

Also, the configurations of air passages 23 for a recording apparatus in accordance with the second embodiment to six embodiment of the present invention are arranged to provide the opening portion 24 on the negative pressure chamber side having a relatively small area as shown in the first embodiment for the portion that faces the common negative pressure chamber 27, which is made narrower on the way to become the portion having the smallest sectional area h. Then, from there toward the guiding surface 21a of the platen 21, the moderately curved wall face is made to gradually approach the face in parallel to the guiding surface 21a. In this manner, the opening area is being increased to provide the largest sectional area H on the opening portion 22 on the guiding surface on the guiding surface 21a, thus blocking any extreme flow-in of the air outside from the opening portion 22 on the guiding surface side which is not covered by the recording medium 1. Therefore, it becomes possible to adsorb the recording medium 1 to the platen 21 more efficiently without reducing the negative pressure in the common negative pressure chamber 27.

Also, for the same reasons, on the edge portions of a recording medium 1, the disturbance of the air flow becomes smaller on the upper face of the plate 21 with respect to the recording medium 1. Then, the disturbance of discharging ink is also made smaller in the discharging direction, hence making it possible to provide a recording apparatus capable of performing high quality recording.

In this respect, the present invention is not necessarily limited to the printer of ink jet type. The invention is also applicable to the recording apparatus of thermal transfer type, which is provided with a platen that should support a recording medium flatly in the recording unit thereof.

As described above, in accordance with the present embodiment, there are provided a plurality of air passages that communicate the first opening portions arranged on the guiding surface of a platen with the second opening portion arranged on the negative pressure generating means side, and each of the air passages is arranged to make the sectional area thereof smaller toward the second opening portion than the first opening portion. As a result, even a curled recording medium can be adsorbed to the platen efficiently, thus providing each air passage which does not allow the adsorbing power to be reduced even when a recording medium covers a part of the opening portion of the platen. In this way, the positional precision and flatness of a recording medium is secured to provide a recording apparatus that can perform recording in high quality.

Also, in accordance with the present embodiment, the relative positional relations between the edge portions of a recording medium that comes to a stop, and the first opening portion that approaches the edge portions is almost the same per intermittent conveyance. Therefore, even a curled recording medium can be adsorbed to the platen efficiently to make it possible to secure the positional precision and flatness of the recording medium for the provision of a recording apparatus capable of recording in high quality.

Also, in accordance with the present embodiment, it is arranged that when a recording medium is conveyed intermittently on the guiding surface, the edges of the recording medium that comes to a stop are in the positional relations not to cover a part of the first opening portion. As a result, there is no disturbance resulting in the ink discharging direction due to the disturbance of the air flow in the vicinity of the edge portions of the recording medium, hence making it possible to provide a recording apparatus capable of performing high quality recording. Also, even a curled recording medium can be adsorbed to the platen efficiently to secure the positional precision and flatness of the recording medium, thus making it possible to provide a recording apparatus capable of perforating high quality recording.

What is claimed is:

1. A recording apparatus for recording images on a recording medium by use of recording means comprising:
a platen having a guiding surface for supporting said recording medium in a position facing recording means;
negative pressure generating means for generating negative pressure to adsorb said recording medium to said guiding surface; and
a plurality of air passages communicating a first opening portion arranged on said guiding surface and a second opening portion arranged on said negative pressure generating means side, the sectional area of said first opening portion being smaller than the sectional area of said second opening porting for each of said air passages.

2. A recording apparatus according to claim 1, wherein said plurality of air passages are structured by moderately curved walls from said second opening portion side toward said first opening portion side to gradually approach the face parallel to said guiding surface of said platen.

3. A recording apparatus according to claim 1, wherein with the quotient obtainable by dividing the sectional area of said second opening portion by the sectional area of said first opening portion being defined as an opening rate, the opening rate of the air passage corresponding to the leading end portion of said recording medium in the conveying direction of said recording medium is made larger than the opening rate of the air passage corresponding to the portion other than the leading end portion of said recording medium.

4. A recording apparatus according to claim 1, wherein with the quotient obtainable by dividing the sectional area of said second opening portion by the sectional area of said first opening portion being defined as an opening rate, the opening rate of the air passage corresponding to the edge portion of said recording medium in the widthwise direction of said recording medium is made larger than the opening rate of the air passage corresponding to the portion other than the edge portion of said recording medium.

5. A recording apparatus according to claim 1, wherein said recording means is an ink jet recording head for discharging ink from the ink discharge ports to a recording medium for recording.

6. A recording apparatus according to claim 5, wherein said ink jet recording head is provided with electrothermal transducing devices for generating energy for discharging ink.

7. A recording apparatus for recording images on a recording medium by use of recording means comprising:
a platen having the guiding surface in a position facing recording means to support said recording medium;
negative pressure generating means for generating negative pressure to adsorb said recording medium to said guiding surface; and
a plurality of air passages communicating a first opening portion arranged on said guiding surface and a second opening portion arranged on said negative pressure generating means side, wherein
when said recording medium is intermittently conveyed on said guiding surface, the relative positional relations between the edge portion of the recording medium at rest and said first opening portion near said edge portion is substantially the same per intermittent conveyance.

8. A recording apparatus according to claim 7, wherein the leading end portion of said recording medium at rest in the conveying direction is not in a position to cover said first opening portion partly.

9. A recording apparatus according to claim 7, wherein the amount of conveyance at the time of said recording medium being intermittently conveyed is integral times the arrangement pitches of the first opening portion in the conveying direction of said recording medium.

10. A recording apparatus according to claim 9, wherein the left and right edge portions of said recording medium at rest in the widthwise direction are not in positions to cover said first opening portion partly.

11. A recording apparatus according to claim 7, wherein the sectional area of said second opening portion is smaller than the sectional area of said first opening portion for each of said plurality of air passages.

12. A recording apparatus according to claim 7, wherein said recording means is an ink jet recording head for discharging ink from the ink discharge ports to a recording medium for recording.

13. A recording apparatus according to claim 12, wherein said ink jet recording head is provided with electrothermal transducing devices for generating energy for discharging ink.

14. A recording apparatus for recording images on a recording medium by use of recording means comprising:
a platen having the guiding surface in a position facing recording means to support said recording medium;
negative pressure generating means for generating negative pressure to adsorb said recording medium to said guiding surface; and
a plurality of air passages communicating a first opening portion arranged on said guiding surface and a second opening portion arranged on said negative pressure generating means side, wherein
when said recording medium is intermittently conveyed on said guiding surface, the edge portion of the recording medium at rest is not in a position to cover said first opening portion partly.

15. A recording apparatus according to claim 14, wherein the leading end portion of said recording medium at rest in the conveying direction is not in a position to cover said first opening portion partly.

16. A recording apparatus according to claim 14, wherein the amount of conveyance at the time of said recording medium being intermittently conveyed is integral times the arrangement pitches of the first opening portion in the conveying direction of said recording medium.

17. A recording apparatus according to claim 16, wherein the left and right edge portions of said recording medium at rest in the widthwise direction are not in positions to cover said first opening portion partly.

18. A recording apparatus according to claim 14, wherein the sectional area of said second opening portion is smaller than the sectional area of said first opening portion for each of said plurality of air passages.

19. A recording apparatus according to claim 14, wherein said recording means is an ink jet recording head for discharging ink from the ink discharge ports to a recording medium for recording.

20. A recording apparatus according to claim 19, wherein said ink jet recording head is provided with electrothermal transducing devices for generating energy for discharging ink.

21. A recording apparatus for recording images on a recording medium by use of recording means comprising:
a platen having the guiding surface in a position facing recording means to support said recording medium;
negative pressure generating means for generating negative pressure to adsorb said recording medium to said guiding surface; and
a plurality of air passages communicating a first opening portion arranged on said guiding surface and a second opening portion arranged on said negative pressure generating means side, wherein
when said recording medium is intermittently conveyed on said guiding surface, the arrangement pitches of the first opening portion corresponding to the leading end portion of the recording medium at rest in the conveying direction of said recording medium is made smaller than the arrangement pitches of the first opening portion corresponding to the portion other than the leading end portion of said recording medium at rest.

22. A recording apparatus according to claim 21, wherein the sectional area of said second opening portion is smaller than the sectional area of said first opening portion for each of said plurality of air passages.

23. A recording apparatus according to claim 22, wherein said recording means is an ink jet recording head for discharging ink from the ink discharge ports to a recording medium for recording.

24. A recording apparatus according to claim 23, wherein said ink jet recording head is provided with electrothermal transducing devices for generating energy for discharging ink.

25. A recording apparatus for recording images on a recording medium by use of recording means comprising:
a platen having the guiding surface in a position facing recording means to support said recording medium;
negative pressure generating means for generating negative pressure to adsorb said recording medium to said guiding surface; and
a plurality of air passages communicating a first opening portion arranged on said guiding surface and a second opening portion arranged on said negative pressure generating means side, wherein
when said recording medium is intermittently conveyed on said guiding surface, the arrangement pitches of the first opening portion corresponding to the left and right edge portions of the recording medium at rest in the widthwise direction of said recording medium is made smaller than the arrangement pitches of the first opening portion corresponding to the portion other than the left and right edge portions of said recording medium at rest.

26. A recording apparatus according to claim 25, wherein the sectional area of said second opening portion is smaller than the sectional area of said first opening portion for each of said plurality of air passages.

27. A recording apparatus according to claim 25, wherein said recording means is an ink jet recording head for discharging ink from the ink discharge ports to a recording medium for recording.

28. A recording apparatus according to claim 27, wherein said ink jet recording head is provided with electrothermal transducing devices for generating energy for discharging ink.
